(19) United States
(12) Patent Application Publication
(10) Pub. No.: US 2023/0237262 A1
(43) Pub. Date: Jul. 27, 2023

(54) CLASSIFICATION DEVICE, CLASSIFICATION METHOD AND CLASSIFICATION PROGRAM

(71) Applicant: Nippon Telegraph and Telephone Corporation, Tokyo (JP)

(72) Inventors: Yuki Urabe, Musashino-shi, Tokyo (JP); Shiro Ogasawara, Musashino-shi, Tokyo (JP); Tomonori Mori, Musashino-shi, Tokyo (JP)

(21) Appl. No.: 18/010,960

(22) PCT Filed: Jun. 24, 2020
(86) PCT No.: PCT/JP2020/024918

§ 371 Date: Dec. 16, 2022

(51) Int. Cl. G06F 40/279; G06F 16/35

(52) U.S. Cl. CPC G06F 40/279; G06F 16/35

(57) ABSTRACT

An extraction unit (15b) extracts words included in information related to work. A calculation unit (15c) calculates a degree of infrequency of appearance with respect to each of the extracted words. A classification unit (15d) classifies the information related to the work issue by issue, by using the calculated degrees of infrequency of appearance of the words.

### TECHNICAL FIELD

The present invention is related to a classification device, a classification method, and a classification program.

### BACKGROUND ART

Generally speaking, in a work environment, information related to work such as specification documents and estimate documents is managed by using a work system or files and is edited and referenced through a screen of the work system or an application program such as Office. Further, what is displayed on a screen during work is recorded in the form of an image or text by using an operation log acquisition tool.

During work, the abovementioned information related to past issues may be referenced in some situations. Further, a technique is disclosed (see Non-Patent Literature 1) by which, for the purpose of analyzing work, the time required to process an issue or a workflow is understood from an operation log of a worker in which information related to the work is included in the form of what was displayed on a screen during the work.

### CITATION LIST

### Non-Patent Literature

Non-Patent Literature 1: Fumihiro Yokose, and five others, “Operation Visualization Technology to Support Digital Transformation”, February 2020, NTT Gijutsu Journal, pp. 72-75

### SUMMARY OF THE INVENTION

### Technical Problem

According to conventional techniques, however, it is sometimes difficult to search for information related to work with respect to each issue. For example, the abovementioned information is not managed issue by issue, but is scattered among files placed in separate work systems or at separate locations. Accordingly, it takes time and effort to search for information with respect to each issue. Furthermore, although it is easy to classify operation logs in units of screens or applications, it is difficult to check, in units of issues, operation logs of certain work that was performed while using a plurality of applications.

Further, to manage all the information by using issue numbers, it would be necessary to manually assign the issue numbers, which would take time and effort. In addition, when information is classified while using all the words included in the information, the information may be classified according to information types that use mutually-different formats such as design documents and estimate documents. Thus, the information may not be classified issue by issue in some situations.

In view of the circumstances described above, it is an object of the present invention to make it possible to easily classify information related to work issue by issue.

### Means for Solving the Problem

To solve the abovementioned problems and achieve the object, a classification device according to the present invention includes: an extraction unit that extracts words included in information related to work; a calculation unit that calculates a degree of infrequency of appearance with respect to each of the extracted words; and a classification unit that classifies the information related to the work issue by issue, by using the calculated degrees of infrequency of appearance.

### Effects of the Invention

According to the present invention, it is possible to easily classify the information related to the work issue by issue.

### BRIEF DESCRIPTION OF DRAWINGS

FIG. 1 is a drawing for explaining an outline of processes performed by a classification device according to embodiments of the present disclosure.

FIG. 2 is a schematic diagram showing an example of a schematic configuration of the classification device according to the present embodiments.

FIG. 3 is a drawing for explaining processes performed by an extraction unit and a calculation unit.

FIG. 4 is a drawing for explaining processes performed by a classification unit.

FIG. 5 is another drawing for explaining the processes performed by the classification unit.

FIG. 6 is yet another drawing for explaining the processes performed by the classification unit.

FIG. 7 is a drawing for explaining processes performed by the extraction unit.

FIG. 8 is yet another drawing for explaining the processes performed by the classification unit.

FIG. 9 is yet another drawing for explaining the processes performed by the classification unit.

FIG. 10 is another drawing for explaining the processes performed by the extraction unit.

FIG. 11 is yet another drawing for explaining the processes performed by the extraction unit.

FIG. 12 is a flowchart showing classification processing procedures.

FIG. 13 is another flowchart showing the classification processing procedures.

FIG. 14 is yet another flowchart showing the classification processing procedures.

FIG. 15 is yet another flowchart showing the classification processing procedures.

FIG. 16 is yet another flowchart showing the classification processing procedures.

FIG. 17 is yet another flowchart showing the classification processing procedures.

FIG. 18 is yet another flowchart showing the classification processing procedures.

FIG. 19 is yet another flowchart showing the classification processing procedures.

FIG. 20 is yet another flowchart showing the classification processing procedures.

FIG. 21 is a diagram showing an example of a computer that executes a classification program.

### DESCRIPTION OF EMBODIMENTS

The following will describe in detail a number of embodiments of the present invention, with reference to the drawings. Further, the present invention is not limited by these embodiments. Further, in the drawings, some of the elements that are mutually the same will be referred to by using mutually the same reference characters.

### An Outline of Processes Performed by A Classification Device

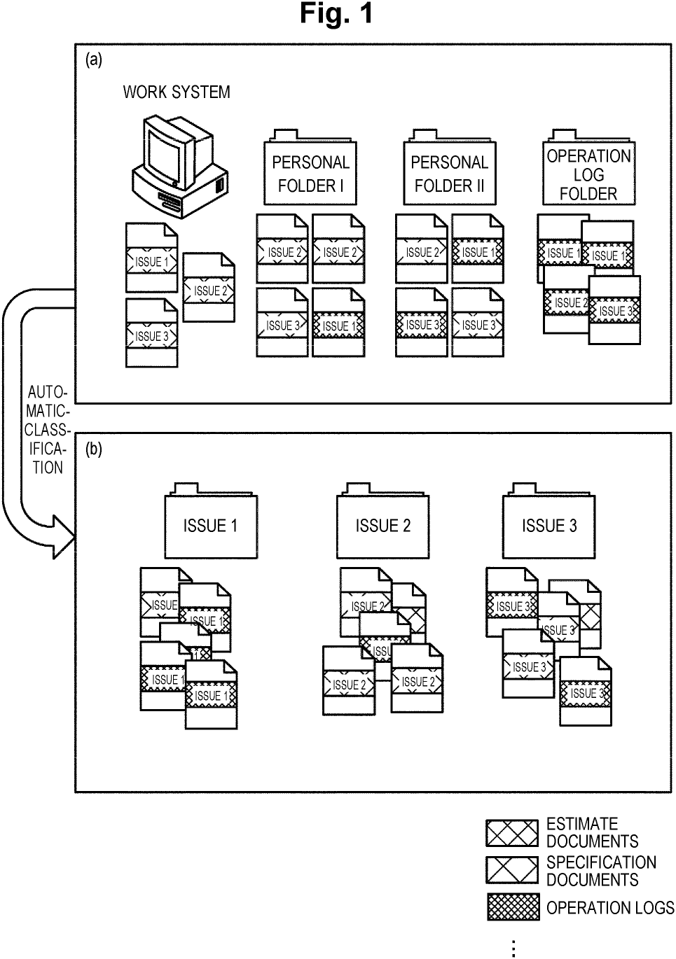

FIG. 1 is a drawing for explaining an outline of processes performed by a classification device according to the present embodiments. For example, as shown in FIG. 1(a), information related to work such as specification documents, estimate documents, and operation logs is not managed issue by issue, but is managed in a scattered manner regardless of the issues, in files stored in a work system or personal folders in operation terminals of the workers.

Further, during work or when performing a work analysis, a user may wish to reference past information with respect to each issue. Accordingly, as shown in FIG. 1(b), the classification device of the present embodiments automatically classifies, issue by issue, the pieces of information of mutually-different information types that are scattered, by performing a classification process (explained later). In that situation, the classification device classifies, as mutually the same issue, certain pieces of information in which, among words included in pieces of information, a word with a high degree of infrequency of appearance appears in common.

### A Configuration of the Classification Device

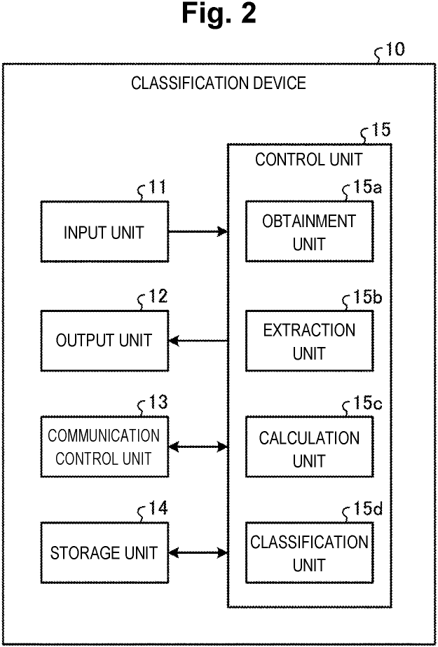

FIG. 2 is a schematic diagram showing an example of a schematic configuration of the classification device according to the present embodiments. As shown in FIG. 2, the classification device 10 of the present embodiments is realized by using a generic computer such as a personal computer and includes an input unit 11, an output unit 12, a communication control unit 13, a storage unit 14, and a control unit 15.

The input unit 11 is realized by using an input device such as a keyboard and a mouse, or the like and inputs, to the control unit 15, various types of instruction information to start processing or the like, in response to input operations performed by an operator. The output unit 12 is realized by using a display device such as a liquid crystal display device, a printing device such as a printer, and the like. For example, on the output unit 12, presented for a user are various types of information that are classified issue by issue, as a result of the classification process explained later.

The communication control unit 13 is realized by using a Network Interface Card (NIC) or the like and controls communication between an external device and the control unit 15 performed via an electrical communication line such as a Local Area Network (LAN) or the Internet. For example, the communication control unit 13 controls communication between the control unit 15 and a shared server or the like that manages intra-corporate emails and work documents such as various types of reports.

The storage unit 14 is realized by using a semiconductor memory element such as a Random Access Memory (RAM) or a flash memory, or a storage device such as a hard disk or an optical disk. In the storage unit 14, a processing program that brings the classification device 10 into operation as well as data used during execution of the processing program are either stored in advance or temporarily stored every time processing is performed. Alternatively, the storage unit 14 may be configured to communicate with the control unit 15 via the communication control unit 13.

In the present embodiments, for example, the storage unit 14 stores therein information related to work in the past. The information is represented by data of mutually-different information types such as specification documents, estimate documents, operation logs, and the like. For example, an obtainment unit 15a (explained later) obtains these pieces of information prior to the classification process (explained later) either regularly or with appropriate timing such as when the user issues an instruction to classify the information, so as to be accumulated in the storage unit 14. Further, as a result of the classification process, the storage unit 14 stores therein the pieces of information that are classified issue by issue.

The control unit 15 is realized by using a Central Processing Unit (CPU) or the like and executes the processing program stored in a memory. As a result, as shown in FIG. 2, the control unit 15 functions as the obtainment unit 15a, an extraction unit 15b, a calculation unit 15c, and a classification unit 15d. One or more of these functional units may be installed in mutually-different pieces of hardware. For example, the obtainment unit 15a and the extraction unit 15b may be installed in a piece of hardware different from a piece of hardware in which the calculation unit 15c and the classification unit 15d are installed. Further, the control unit 15 may include any other functional unit.

### First Embodiment

The obtainment unit 15a obtains the information related to the work in the past. For example, the obtainment unit 15a acquires the information related to the work in the past from the work system, the terminals of the workers, and the like via the communication control unit 13 so as to be stored into the storage unit 14. Prior to the classification process (explained later), the obtainment unit 15a obtains the information related to the work in the past, either regularly or with appropriate timing such as when the user issues an instruction to classify the information. Further, the obtainment unit 15a does not necessarily have to store the information in the storage unit 14 and, for example, may obtain the information when the classification process (explained later) is to be performed.

The extraction unit 15b extracts words included in the information related to the work. More specifically, the extraction unit 15b extracts the words from all the pieces of information related to the work obtained by the obtainment unit 15a.

With respect to each of the extracted words, the calculation unit 15c calculates a degree of infrequency of appearance. For example, by using an IDF value, the calculation unit 15c calculates the degree of infrequency of appearance in all the pieces of information, with respect to each of the words “w” extracted by the extraction unit 15b, as show in the following Expression (1)

[Math. 1]

$$I D {F}_{w} = log \left(\frac{N}{d f \left(w\right) + 1}\right)$$

where
N: the number of pieces of information; and
df(w): the number of times the word w appeared in the information.

The IDF value expresses the degree of infrequency of appearance of each word. The less frequently a word appears, the larger is the IDF value. For example, when a word appears in common in all the pieces of information, the degree of infrequency of appearance is low. Further, in the classification process of the present embodiment, pieces of information in which a word with a large value indicating the degree of infrequency of appearance appears in common are classified as mutually the same issue.

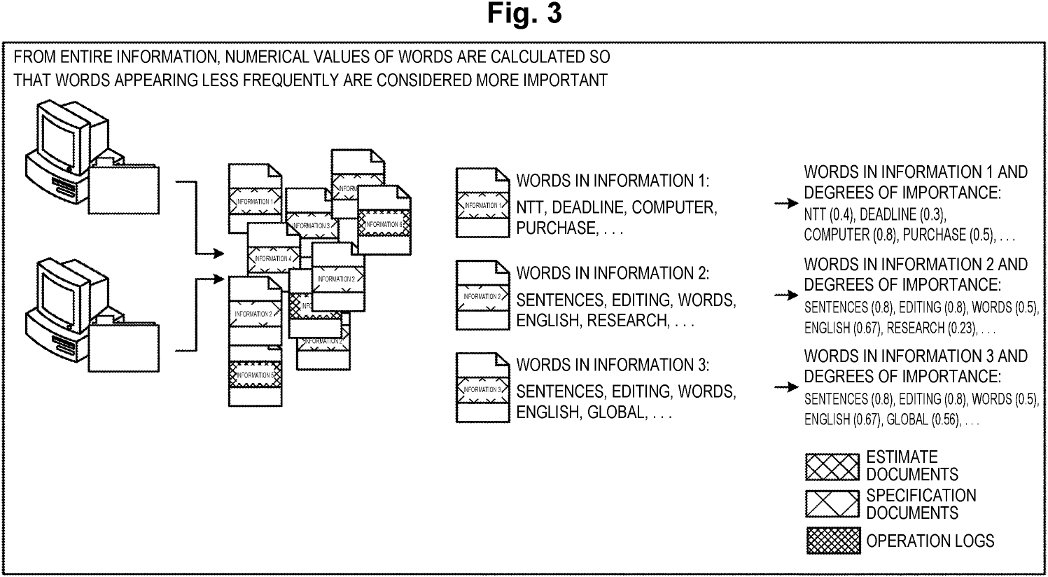

FIG. 3 is a drawing for explaining processes performed by the extraction unit and the calculation unit. In the example in FIG. 3, IDF values are calculated as the degrees of infrequency of appearance of the words extracted from each of the pieces of information, information 1 to 3. (“The degrees of infrequency of appearance” may hereinafter be referred to as degrees of importance”) For example, as the words from information 1, words such as NTT, deadline, computer, purchase, and so on are extracted. Further, degrees of importance of the words are calculated as 0.4, 0.3, 0.8, 0.5, and so on.

Returning to the description of FIG. 2. The classification unit 15d classifies the information related to the work issue by issue, by using the calculated degrees of infrequency of appearance of the words. In other words, the classification unit 15d classifies, as mutually the same issue, pieces of information in which a word with a high degree of importance expressed with the degree of infrequency of appearance appears in common.

More specifically, among words each having the calculated degree of infrequency of appearance that is equal to or higher than a predetermined threshold value, when the quantity of, or the sum of the degrees of infrequency of appearance of, the words appearing in common in certain pieces of information related to the work is equal to or larger than a predetermined threshold value, the classification unit 15d classifies those pieces of information related to the work as mutually the same issue.

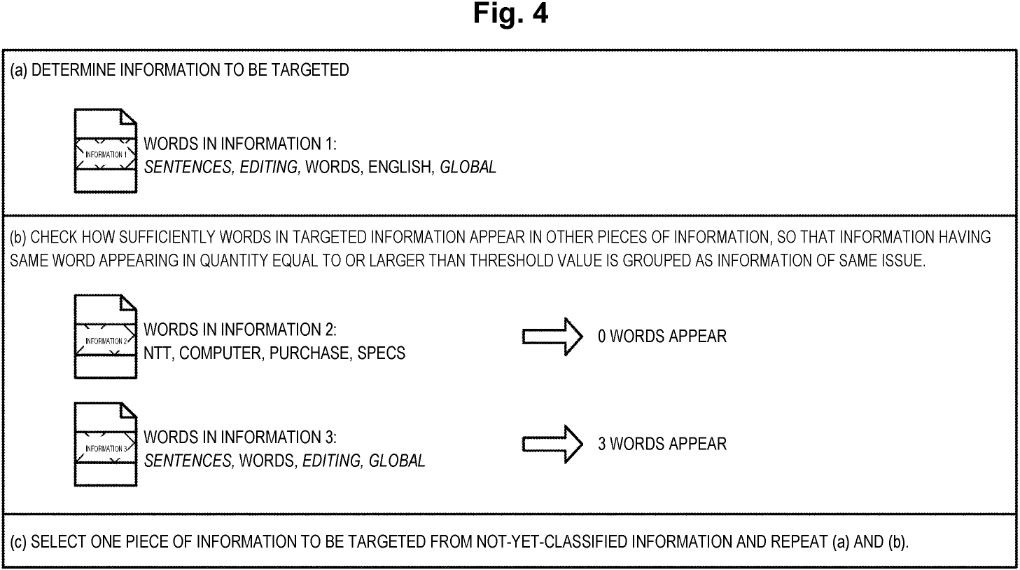

FIGS. 4 to 6 are drawings for explaining processes performed by the classification unit. For example, as shown in FIG. 4, among the words included in targeted information, when certain words each having a particularly high degree of importance appear in common in another piece of information, the classification unit 15d classifies the other piece of information as the same issue, if the words appear in common in the largest quantity or in a quantity equal to or larger than a predetermined threshold value. In this situation, the quantity of the words may be the quantity of types of words or a total quantity of words.

In the example in FIG. 4, as shown in FIG. 4(a), taking information 1 as a target, it is checked to see whether or not the words that are included in information 1 and that each have a degree of importance equal to or higher than the predetermined threshold value, namely “sentences”, “editing”, “words”, “English”, and “global”, appear in the other pieces of information.

As a result, as shown in FIG. 4(b), the quantity of the words appearing in common in information 2 is zero, whereas the quantity of the words appearing in common in information 3 is three words “sentences”, “editing”, and “global”. In this situation, when the threshold value for the quantity of types of words used for classification of mutually the same issue is 2, for example, the classification unit 15d classifies information 1 and information 3 as mutually the same issue. Further, as shown in FIG. 4(c), the classification unit 15d classifies all the pieces of information issue by issue, by repeatedly performing the processes shown in FIGS. 4(a) and 4(b), while changing the information to be targeted.

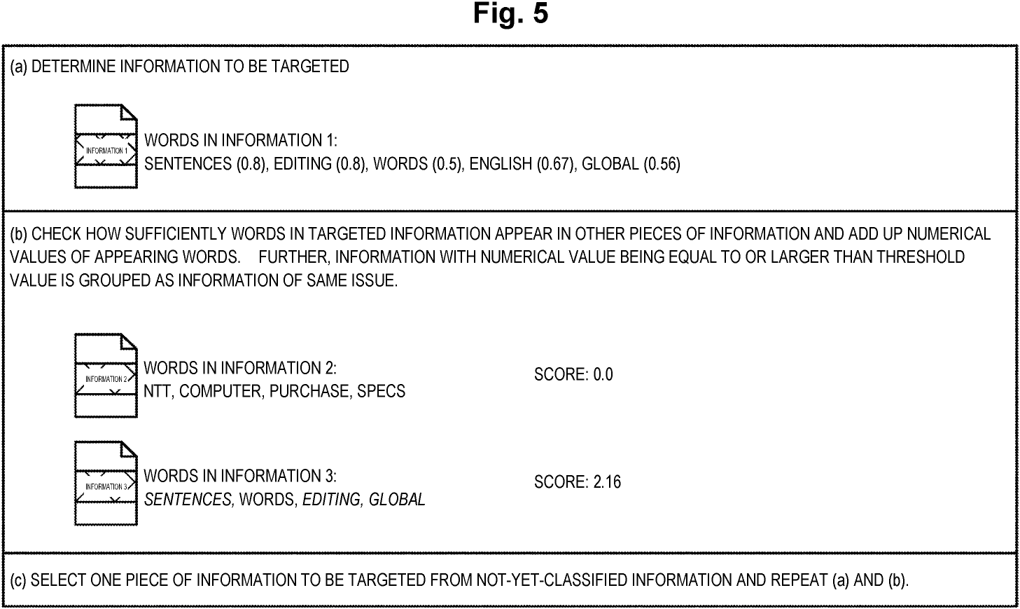

Alternatively, as shown in FIG. 5, when certain words that are included in the targeted information and that each have a degree of importance equal to or higher than the predetermined threshold value appear in common in another piece of information, the classification unit 15d classifies the other piece of information as the same issue, if the sum of the degrees of importance of the words appearing in common is largest or is equal to or larger than a predetermined threshold value.

In the example in FIG. 5, as shown in FIG. 5(a), taking information 1 as a target, it is checked to see whether or not the words “sentences”, “editing”, “words”, “English”, and “global” included in information 1 appear in the other pieces of information. Scores indicating the degrees of importance of the words in information 1 are 0.8, 0.8, 0.5, 0.67, and 0.56.

As a result, as shown in FIG. 5(b), the quantity of the words appearing in common in information 2 is zero, while the sum of the degrees of importance is 0. The three words, namely “English”, “editing”, and “global” appear in common in information 3, while the sum of the scores thereof is 2.16. In this situation, when the threshold value for the sum of the scores for classification of mutually the same issue is 2, for example, the classification unit 15d classifies information 1 and information 3 as mutually the same issue. Further, as shown in FIG. 5(c), the classification unit 15d classifies all the pieces of information issue by issue, by repeatedly performing the processes shown in FIGS. 5(a) and 5(b), while changing the information to be targeted.

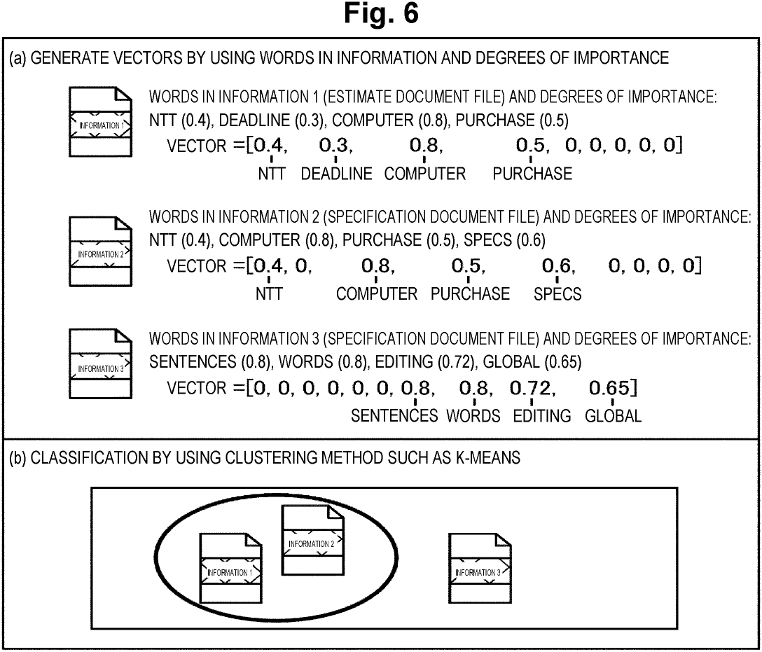

Alternatively, as shown in FIG. 6, the classification unit 15d may classify all the pieces of information issue by issue, by generating vectors while using certain words that are included in the pieces of information and that each have a degree of importance equal to or higher than a predetermined threshold value as well as the degrees of importance thereof and further classifying the vectors.

In the example in FIG. 6, as shown in FIG. 6(a), by using the words included in the pieces of information and the degrees of importance thereof, the classification unit 15d generates a vector in which the number of dimensions denotes the quantity of types of words having a degree of importance equal to or higher than the predetermined threshold value. For example, by using the words included in information 1 representing an estimate document and the degrees of importance thereof, a vector = [0.4,0.3,0.8,0.5,0,0,0,0,0] in which the number of dimensions denotes the quantity of all the types of words (i.e., 9) is generated. After that, as shown in FIG. 6(b), the classification unit 15d classifies all the pieces of information issue by issue, by classifying the generated vectors while using a clustering method such as K-means.

### Second Embodiment

Returning to the description of FIG. 2. The extraction unit 15b may extract the words from the information related to the work, with respect to each of the information types of the information related to the work. In the present embodiment, it is assumed that the pieces of information are classified in advance according to the information types.

Further, in that situation, from the words extracted with respect to each of the information types, the extraction unit 15b may exclude a word included in all the pieces of information in each information type. In other words, the extraction unit 15b may exclude the words (in-common words) that appear in common regardless of issues, in format sections or the like of the information of each information type. As a result, it is possible to extract information unique to each of the issues more accurately.

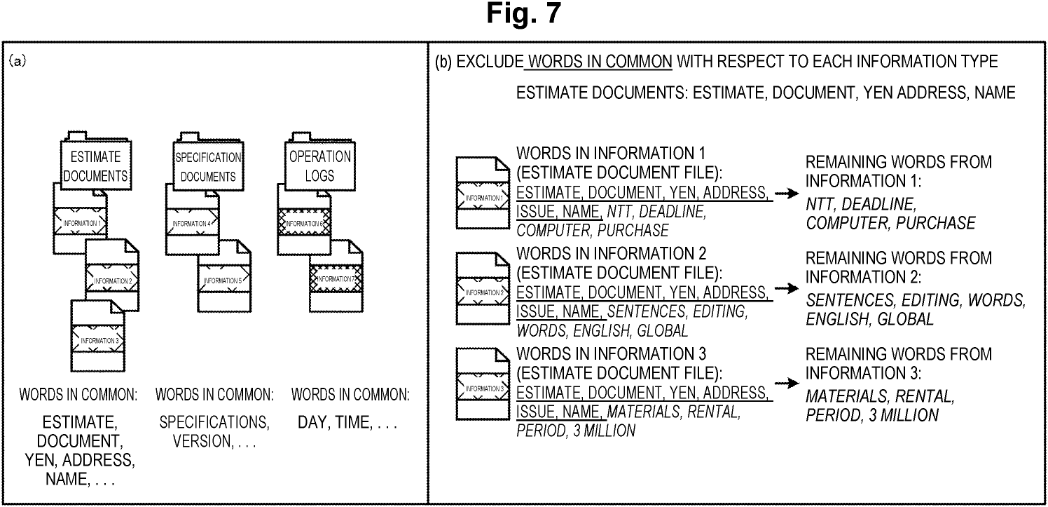

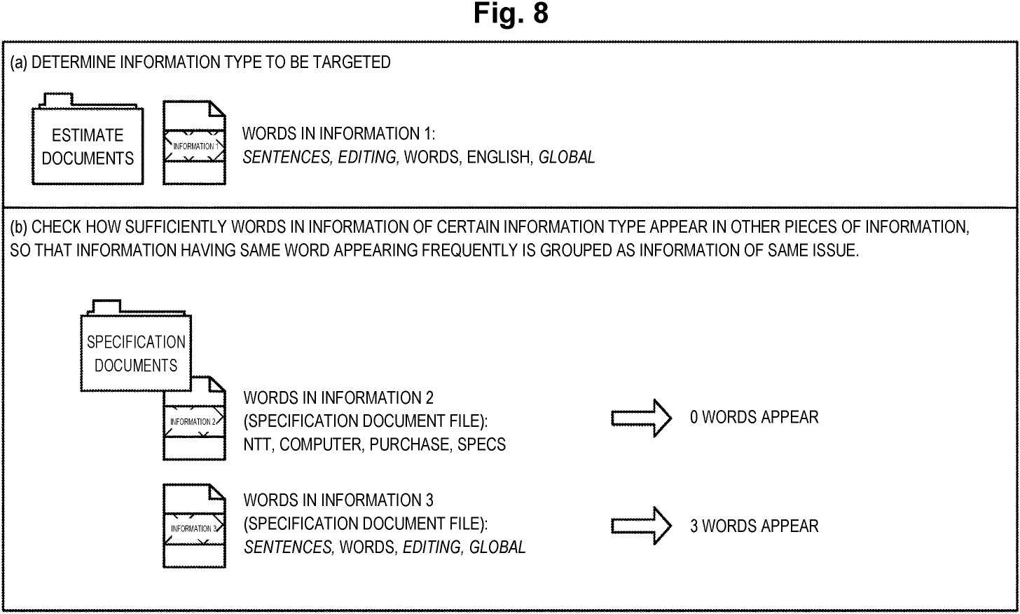

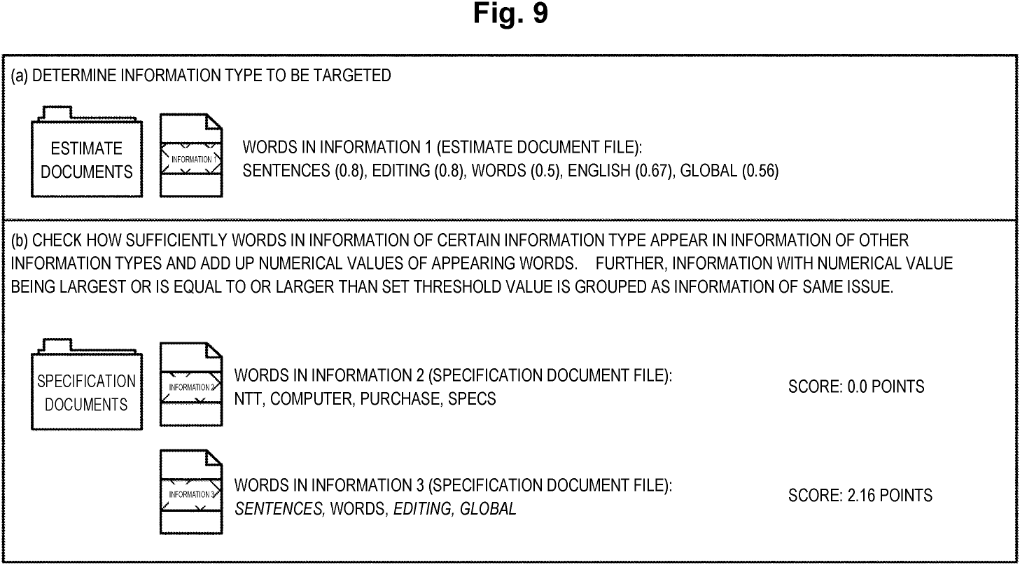

Next, the second embodiment will be explained with reference to FIGS. 7 to 9. FIG. 7 is a drawing for explaining processes performed by the extraction unit. FIGS. 8 and 9 are drawings for explaining processes performed by the classification unit. FIGS. 8 and 9 are different from FIGS. 4 and 5 above in that, taking pieces of information of an information type as reference, pieces of information of the other information types are classified issue by issue.

For instance, in the example in FIG. 7, as shown in FIG. 7(a), the pieces of information are classified, in advance, according to the information types such as estimate documents, specification documents, and operation logs. Further, as shown in FIG. 7(b), with respect to each of the information types, in-common words that are included in common in all the pieces of information are excluded from the extracted words. In the example in FIG. 7(b), “estimate, document, yen, address, and name” are excluded as the in-common words of estimate documents.

In this situation, the calculation unit 15c calculates the degrees of importance of the words excluding the in-common words. Further, with respect to the information of the targeted information type, when certain words each having a particularly high degree of importance among the words included in the information appear in common in a piece of information of another information type, the classification unit 15d classifies the piece of information as the same issue, if the words appear in common in the largest quantity or in a quantity equal to or larger than a predetermined threshold value. In this situation, the quantity of the words may be the quantity of types of words or a total quantity of words.

In the example in FIG. 8, as shown in FIG. 8(a), while using estimate documents as a targeted information type, it is checked to see whether or not the words “sentences”, “editing”, “words”, “English”, and “global” which are included in information 1 representing the estimate document and which remain after the in-common words are excluded appear in the information of the other information types.

As a result, as shown in FIG. 8(b), in the specification documents, the quantity of the words appearing in common in information 2 is 0, whereas the quantity of the words appearing in common in information 3 is three words “sentences”, “editing”, and “global”. In this situation, when the threshold value for the quantity of types of words for classification of mutually the same issue is 2, for example, the classification unit 15d classifies information 1 representing the estimate document and information 3 as mutually the same issue.

In another example, when certain words that are included in the information of the targeted information type and that each have a degree of importance equal to or larger than a threshold value appear in common in a piece of information of another information type, the classification unit 15d classifies the piece of information as the same issue, if the sum of the degrees of importance of the words appearing in common is largest or is equal to or larger than a predetermined threshold value.

In the example in FIG. 9, as shown in FIG. 9(a), taking estimate documents as of a targeted information type, it is checked to see whether the words “sentences”, “editing”, “words”, “English”, and “global” which are included in information 1 representing the estimate document and which remain after the in-common words are excluded appear in the other pieces of information. The scores indicating the degrees of importance of the words are 0.8, 0.8, 0.5, 0.67, and 0.56.

As a result, as shown in FIG. 9(b), among the specification documents, the quantity of the words appearing in common in information 2 is zero, while the sum of the degrees of importance is zero. The quantity of the words appearing in common in information 3 is three words “sentences”, “editing”, and “global”, while the sum of the scores is 2.16. In this situation, when the threshold value for the sum of the scores for classification of mutually the same issue is 2, for example, the classification unit 15d classifies information 1 representing the estimate document and information 3 as mutually the same issue.

In yet another example, as shown in FIG. 6, the classification unit 15d may classify all the pieces of information issue by issue, by generating the vectors while using certain words that are included in the pieces of information and that each have a degree of importance equal to or higher than the predetermined threshold value as well as the degrees of importance thereof and further classifying the vectors. On such occasion, by setting a restriction so as to have pieces of information that belong to mutually-different information types, certain pieces of information that are of the mutually-different information types are grouped as being of mutually the same issue.

### Third Embodiment

In the second embodiment described above, the pieces of information are classified in advance according to the information types; however, the present disclosure is not limited to this example. The extraction unit 15b may extract the words with respect to each of the information types, after employing the classification device 10 of the present invention so as to automatically classify the pieces of information related to the work according to the information types, while using all the words extracted from the information related to the work. With this configuration, it is possible to classify the pieces of information according to the information types automatically and easily.

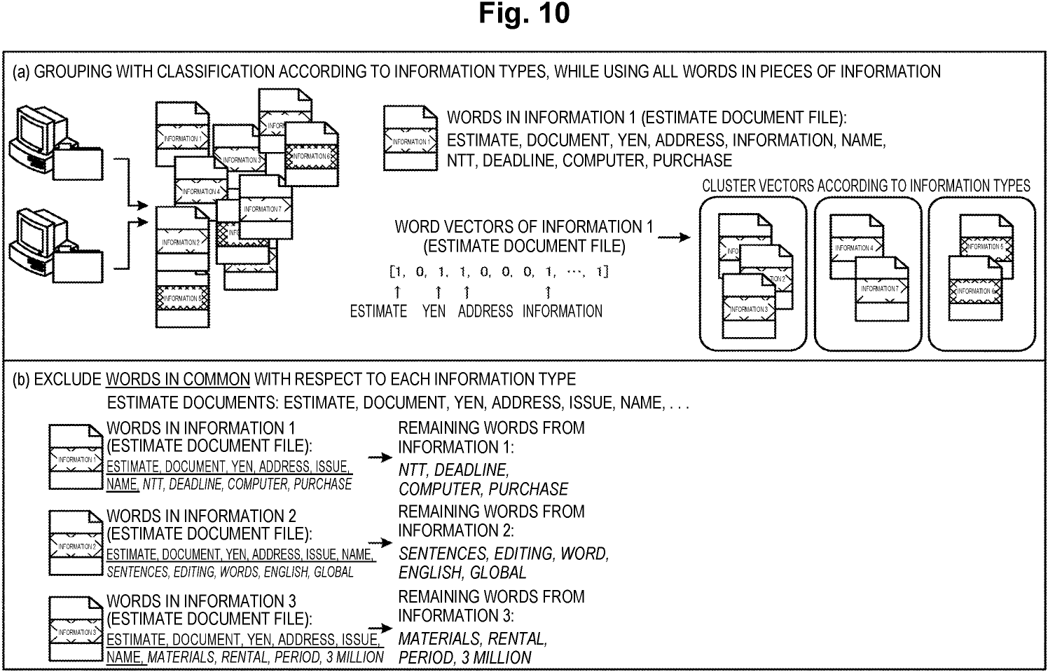

Next, a third embodiment as described above will be explained with reference to FIG. 10. FIG. 10 is a drawing for explaining processes performed by the extraction unit. For example, as shown in FIG. 10(a), the extraction unit 15b classifies all the pieces of information according to the information types, by generating vectors by using all the words included in the pieces of information and further classifying the vectors.

In the example in FIG. 10(a), while using the words included in the pieces of information, the extraction unit 15b generates the vector in which the number of dimensions denotes the quantity of types of words. For example, while using “1” as a vector element corresponding to the words included in information 1 representing the estimate document, a vector = {1,0,1,1,0,0,0,1, . . . 1} in which the number of dimensions denotes the quantity of all the types of words is generated. After that, the classification unit 15d classifies all the pieces of information according to the information types, by classifying the generated vectors while using a clustering method such as K-means.

Further, as shown in FIG. 10(b), similarly to FIG. 7(b), with respect to each of the information types, the in-common words included in common in all the pieces of information are excluded from the extracted words. In the example in FIG. 10(b), as the in-common words among the estimate documents, “estimate, document, yen, address, and name” are excluded.

Because the processes performed by the calculation unit 15c and the classification unit 15d in this situation are the same as those in the second embodiment described above (see FIGS. 8 and 9 and FIG. 6), explanations thereof will be omitted.

### Fourth Embodiment

Further, the method used by the extraction unit 15b for classifying the pieces of information according to the information types is not limited to the third embodiment described above. For instance, the extraction unit 15b may extract the words with respect to each of the information types, after employing the classification device 10 of the present invention so as to automatically classify the pieces of information related to the work according to the information types, while using words included in a template prepared with respect to each of the information types. With this configuration also, it is possible to classify the pieces of information according to the information types automatically and easily.

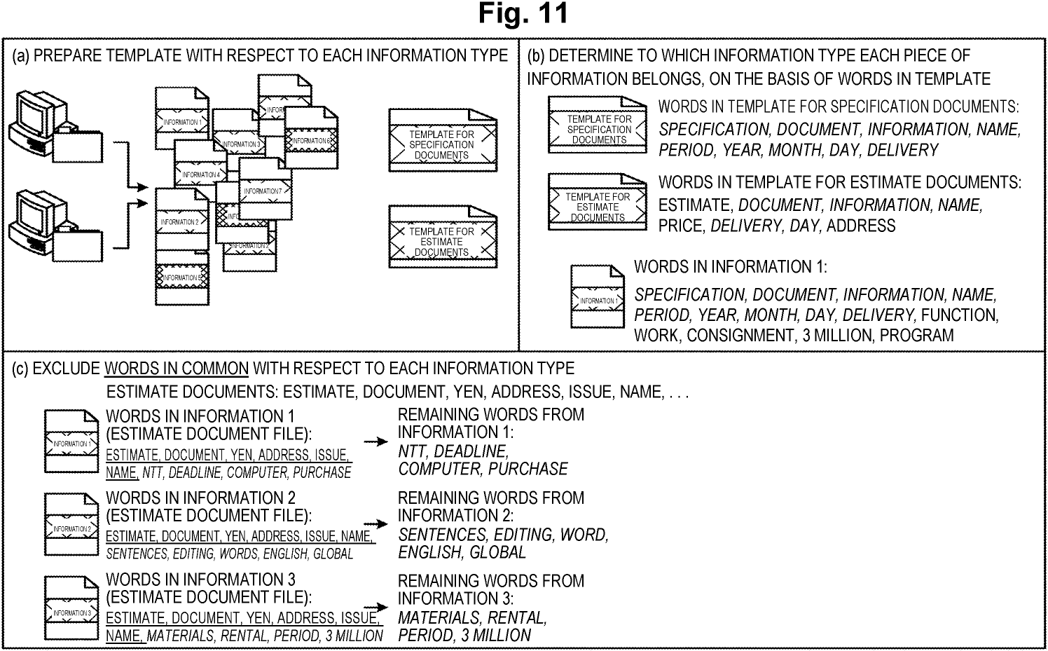

Next, a fourth embodiment as described above will be explained, with reference to FIG. 11. FIG. 11 is a drawing for explaining processes performed by the extraction unit. For example, as shown in FIGS. 11(a) and 11(b), the extraction unit 15b classifies all the pieces of information according to the information types, by comparing the words included in a template corresponding to each of the information types, with the words extracted from the pieces of information.

In the example in FIG. 11, as shown in FIG. 11(b), when certain words from a template prepared for an information type sufficiently appear in a piece of information, the extraction unit 15b classifies the piece of information into the information type corresponding to the template. In the example in FIG. 11(b), because the words included in the template for specification documents sufficiently appear in information 1, the information type of information 1 is determined as a specification document.

Further, as shown in FIG. 11(c), similarly to FIG. 7(b), with respect to each of the information types, the in-common words included in common in all the pieces of information are excluded from the extracted words. In the example in FIG. 11(c), “estimate, document, yen, address, and name” are excluded as the in-common words among the estimate documents.

Because the processes performed by the calculation unit 15c and the classification unit 15d in this situation are the same as those in the second embodiment described above (see FIGS. 8 and 9 and FIG. 6), explanations thereof will be omitted.

### A Classification Process

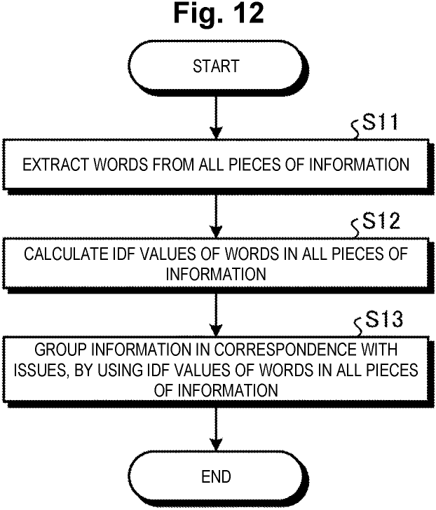

Next, classification processes performed by the classification device 10 according to the present embodiments will be explained, with reference to FIGS. 12 to 20. FIGS. 12 to 20 are flowcharts showing classification processing procedures. At first, FIGS. 12 to 15 show classification processing procedures in the first embodiment described above. The flowchart in FIG. 12 is started at a time when, for example, an operator carries out an operation input to start referencing the information issue by issue.

To begin with, the extraction unit 15b extracts the words from all the pieces of information related to the work (step S11). Subsequently, the calculation unit 15c calculates the IDF values as the degrees of infrequency of appearance of the extracted words (step S12). After that, by using the IDF values of the words, the classification unit 15d classifies the information issue by issue (step S13). As a result, the series of classification processes ends.

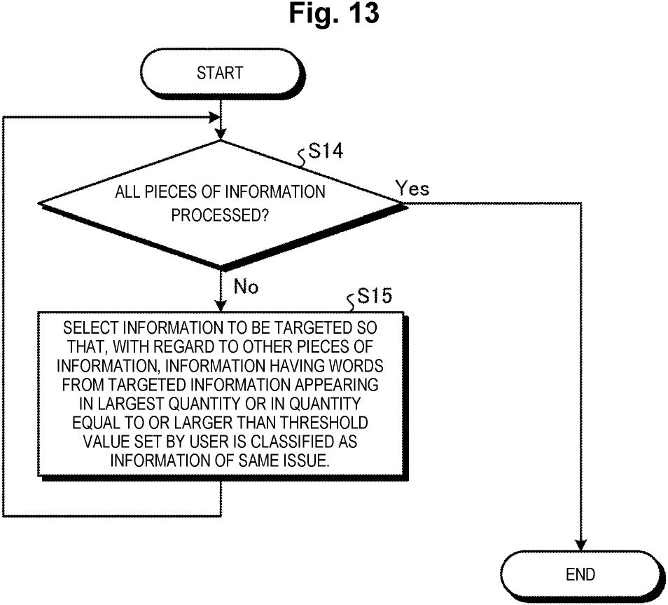

Further, FIGS. 13 to 15 show a detailed procedure in the process in step S13. At first, FIG. 13 shows the processing procedure performed by the classification unit 15d explained above with reference to FIG. 4. While all the pieces of information are still being processed (step S14: No), among the words included in the targeted information, when certain words each having a particularly high degree of importance appear in common in another piece of information, the classification unit 15d classifies the other piece of information as the same issue, if the words appear in common in the largest quantity or in a quantity equal to or larger than the predetermined threshold value (step S15). Further, the classification unit 15d returns the process to step S14, and when all the pieces of information have finished being processed (step S14: Yes), the series of processes ends.

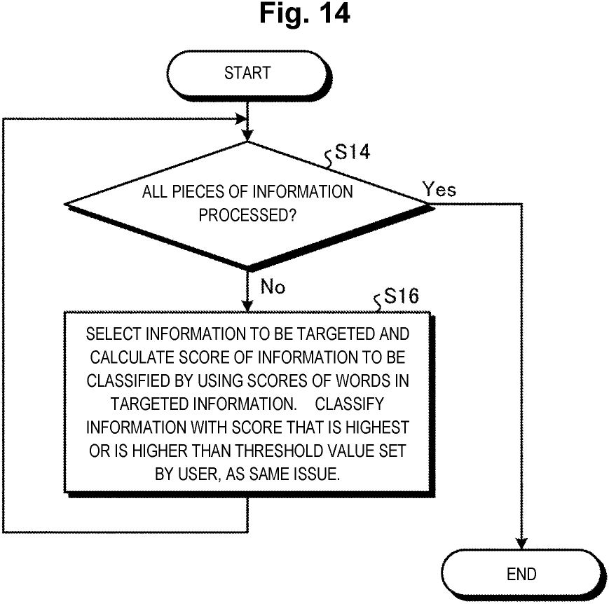

FIG. 14 shows the processing procedure performed by the classification unit 15d explained above with reference to FIG. 5. While all the pieces of information are still being processed (step S14: No), when certain words that are included in the targeted information and that each have a degree of importance score equal to or higher than the predetermined threshold value appear in common in another piece of information, the classification unit 15d classifies the other piece of information as the same issue, if the sum of the scores of the words appearing in common is largest or is equal to or larger than the predetermined threshold value (step S16). Further, the classification unit 15d returns the process to step S14, and when all the pieces of information have finished being processed (step S14: Yes), the series of processes ends.

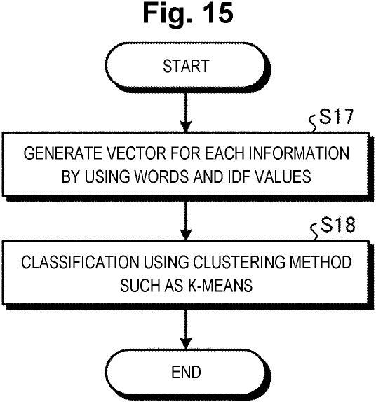

FIG. 15 shows the processing procedure performed by the classification unit 15d explained above with reference to FIG. 6. The classification unit 15d generates the vectors, by using certain words that are included in the pieces of information and that each have a degree of importance equal to or higher than the predetermined threshold value and the IDF values expressing the degrees of importance thereof (step S17). After that, the classification unit 15d classifies the generated vectors by using a method such as K-means, for example (step S18). In this manner, the classification unit 15d classifies all the pieces of information issue by issue, and the series of processes ends.

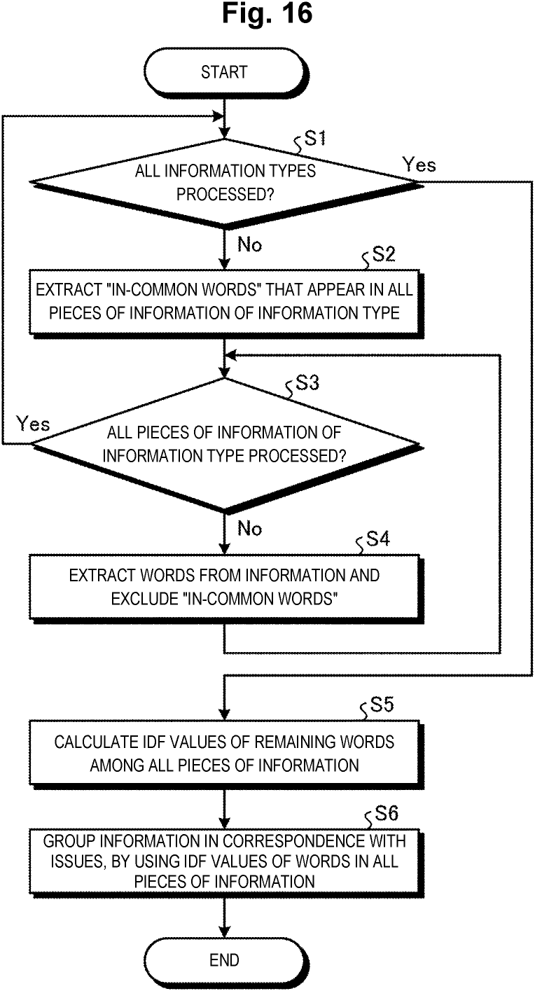

Next, FIGS. 16 to 18 show the classification processing procedure of the second embodiment described above. At first, similarly to FIG. 12, the flowchart in FIG. 16 is started at a time when, for example, the operator carries out an operation input to start referencing the information issue by issue.

To begin with, when all the information types have not finished being processed (step S1: No), the extraction unit 15b extracts the in-common words that appear in common in all the pieces of information related to the work, with respect to each of the information types (step S2). Further, when the words have not finished being extracted from all the pieces of information of the information type (step S3: No), the extraction unit 15b extracts the words from the information and further excludes the in-common words extracted with respect to each of the information types in step S2 (step S4) and returns the process to step S3. On the contrary, when all the pieces of information of the information type have finished being processed (step S3: Yes), the extraction unit 15b returns the process to step S1.

On the contrary, when the extraction unit 15b has finished processing all the information types (step S1: Yes), the calculation unit 15c calculates the IDF values as the degrees of infrequency of appearance with respect to the remaining words among all the pieces of information (step S5). Further, by using the IDF values of the words, the classification unit 15d classifies the pieces of information issue by issue (step S6). As a result, the series of classification processes ends.

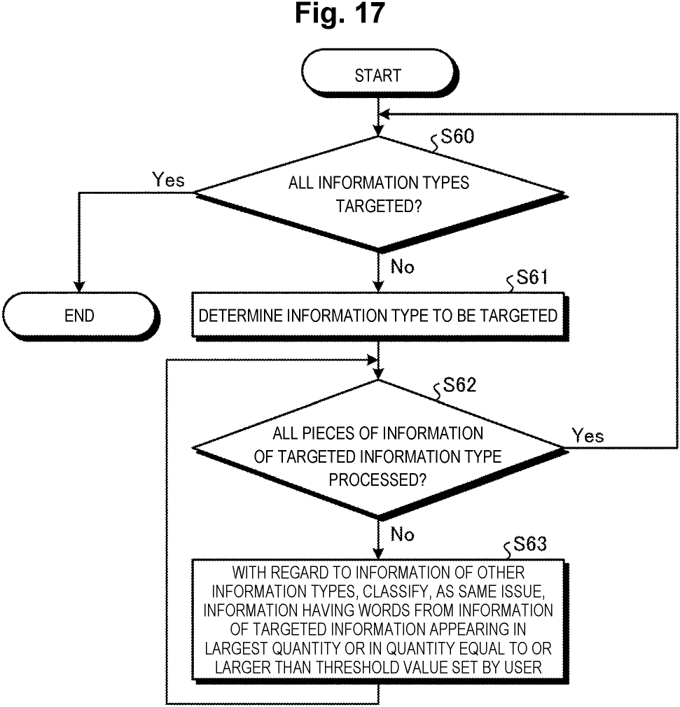

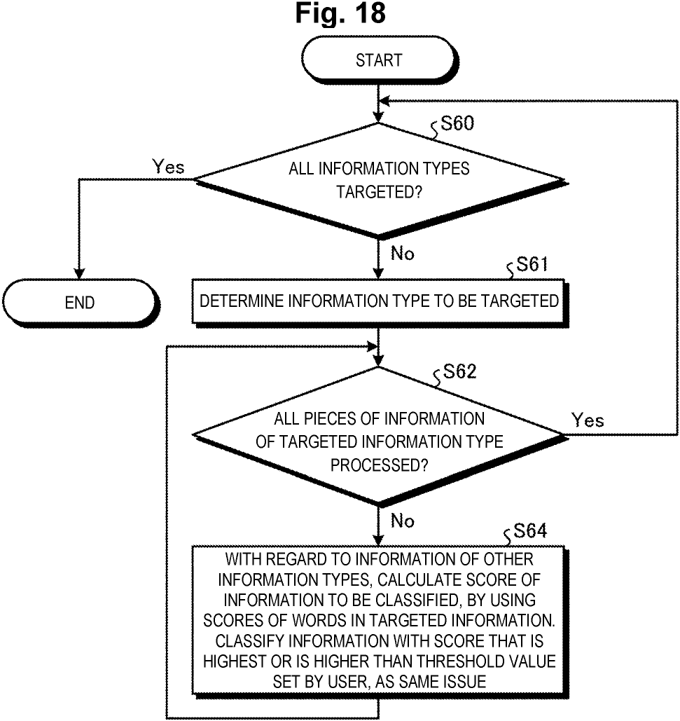

Further, FIGS. 17 and 18 show a detailed procedure in the process in step S6. At first, FIG. 17 shows the processing procedure performed by the classification unit 15d explained above with reference to FIG. 8. When all the information types have not been targeted (step S60: No), the classification unit 15d selects an information type to be targeted (step S61). In this situation, the targeted information type may be designated by a user.

On the contrary, while the information in the targeted information type is still being processed in the classification process (step S62: No), when certain words that are included in the targeted information and that each have a particularly high degree of importance appear in common in a piece of information of another information type, the classification unit 15d classifies the piece of information as the same issue, if the words appear in common in the largest quantity or in a quantity equal to or larger than the predetermined threshold value set by the user in the other information type (step S63). In this situation, the other information type means any of all the information types other than the targeted information type.

Further, the classification unit 15d returns the process to step S62. When all the pieces of information of the information type have finished being classified (step S62: Yes), the process is returned to step S60. Further, when the classification unit 15d have been targeted all the information types (step S60: Yes), the series of processes ends.

FIG. 18 shows a processing procedure performed by the classification unit 15d explained above with reference to FIG. 9. When all the information types have not been targeted (step S60: No), the classification unit 15d selects an information type to be targeted (step S61). In this situation, the targeted information type may be designated by a user.

Further, while the information related to the work of the targeted information type is still being processed in the classification process (step S62: No), when certain words that are included in the targeted information and that each have a degree of importance score equal to or higher than the predetermined threshold value appear in common in a piece of information of another information type, the classification unit 15d classifies the piece of information as the same issue, if the sum of the scores of the words appearing in common is largest or is equal to or larger than the predetermined threshold value in the other information type (step S64). In this situation, the other information type means any of all the information types other than the targeted information type.

Further, the classification unit 15d returns the process to step S62. When all the pieces of information of the information type have finished being classified (step S62: Yes), the process is returned to step S60. When the classification unit 15d have been targeted all the information types (step S60: Yes), the series of processes ends.

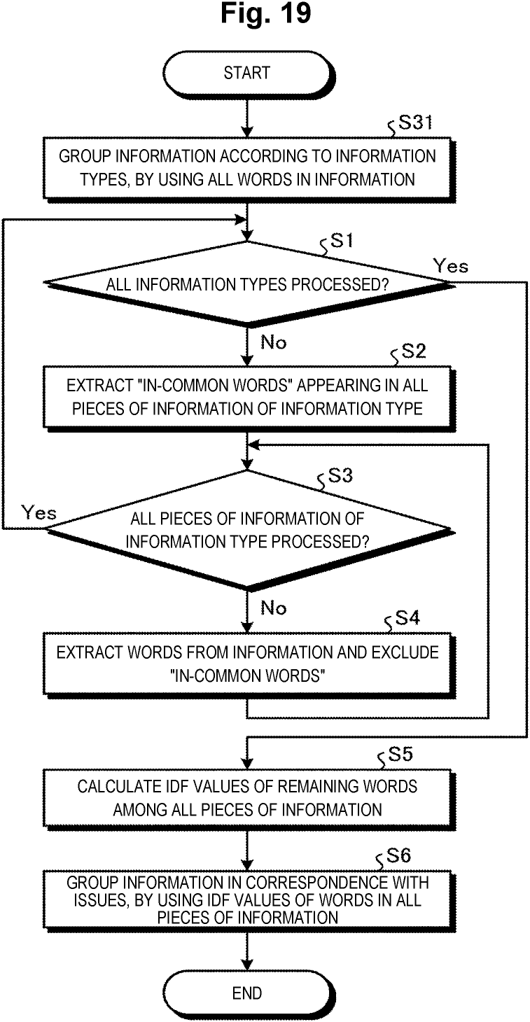

Next, FIG. 19 shows the classification processing procedure of the third embodiment described above. Similarly to FIG. 16, the flowchart in FIG. 19 is started at a time when, for example, the operator carries out an operation input to start referencing the information issue by issue.

To begin with, the extraction unit 15b classifies the information according to the information types, by using all the words extracted from the information related to the work (step S31).

Subsequently, when all the information types have not finished being processed (step S1: No), the extraction unit 15b extracts the in-common words that appear in common in all the pieces of information related to the work, with respect to each of the information types (step S2). Further, when the words have not finished being extracted from all the pieces of information of the information type (step S3: No), the extraction unit 15b extracts the words from the information and further excludes the in-common words extracted with respect to each of the information types in step S2 (step S4) and returns the process to step S3. On the contrary, when all the pieces of information of the information type have finished being processed (step S3: Yes), the extraction unit 15b returns the process to step S1.

On the contrary, when the extraction unit 15b has finished processing all the information types (step S1: Yes), the calculation unit 15c calculates the IDF values as the degrees of infrequency of appearance with respect to the remaining words among all the pieces of information (step S5). Further, by using the IDF values of the words, the classification unit 15d classifies the pieces of information issue by issue (step S6). As a result, the series of classification processes ends.

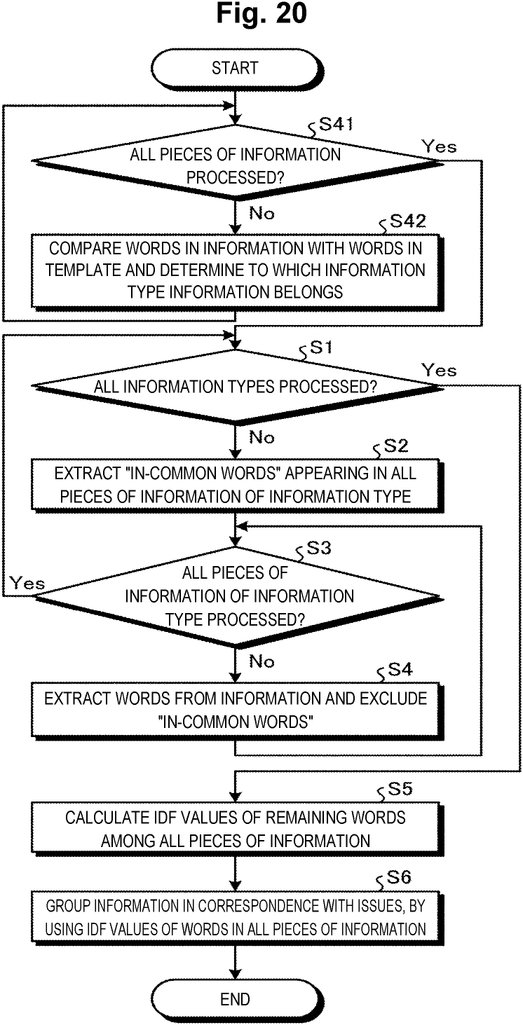

Next, FIG. 20 shows the classification processing procedure of the fourth embodiment described above. Similarly to FIG. 16, the flowchart in FIG. 20 is started at a time when, for example, the operator carries out an operation input to start referencing the information issue by issue.

To begin with, when all the pieces of information have not finished being processed (step S41: No), the extraction unit 15b determines to which information type the piece of information belongs, by comparing the words in the template prepared with respect to each of the information types with the words in the piece of information (step S42) and returns the process to step S41. On the contrary, when all the pieces of information have finished being processed (step S41: Yes), the extraction unit 15b proceeds the process to step S1.

Subsequently, when all the information types have not finished being processed (step S1: No), the extraction unit 15b extracts the in-common words that appear in common in all the pieces of information related to the work, with respect to each of the information types (step S2). Further, when the words have not finished being extracted from all the pieces of information of the information type (step S3: No), the extraction unit 15b extracts the words from the information and further excludes the in-common words extracted with respect to each of the information types in step S2 (step S4) and returns the process to step S3. On the contrary, when all the pieces of information of the information type have finished being processed (step S3: Yes), the extraction unit 15b returns the process to step S1.

On the contrary, when the extraction unit 15b has finished processing all the information types (step S1: Yes), the calculation unit 15c calculates the IDF values as the degrees of infrequency of appearance with respect to the remaining words among all the pieces of information (step S5). Further, by using the IDF values of the words, the classification unit 15d classifies the pieces of information issue by issue (step S6). As a result, the series of classification processes ends.

As explained above, in the classification device 10 according to the present embodiments, the extraction unit 15b extracts the words included in the information related to the work. Further, the calculation unit 15c calculates the degrees of infrequency of appearance with respect to the extracted words. Further, by using the calculated degrees of infrequency of appearance of the words, the classification unit 15d classifies the information related to the work issue by issue.

As a result, while regarding the words having infrequency of appearance as words having high degrees of importance, the classification device 10 is able to classify, as the same issue, certain information that has a word with a high degree of importance appearing in common. In this manner, it is possible to easily classify the information related to the work issue by issue.

Further, the extraction unit 15b may extract the words with respect to each of the information types of the information related to the work. With this configuration, it is possible to more accurately extract the information unique to each issue.

Further, from the words extracted with respect to each of the information types, the extraction unit 15b may exclude a word included in all the pieces of information in each information type. With this configuration, it is possible to more efficiently extract the words having infrequency of appearance.

Further, the extraction unit 15b may extract the words with respect to each of the information types, by classifying the information related to the work according to the information types, by using all the extracted words. With this configuration, it is possible to automatically and easily classify the pieces of information related to the work according to the information types.

Further, the extraction unit 15b may extract the words with respect to each of the information types, by classifying the information related to the work according to the information types, by using the words included in the template prepared with respect to each of the information types. With this configuration, it is possible to automatically and easily classify the pieces of information related to the work, according to the information types.

Further, among the words each having the calculated degree of infrequency of appearance that is equal to or higher than the predetermined threshold value, when the quantity of, or the sum of the degrees of infrequency of appearance of, the words appearing in common in certain pieces of information related to the work is equal to or larger than the predetermined threshold value, the classification unit 15d may classify those pieces of information related to the work as mutually the same issue. With this configuration, it is possible to automatically and more easily classify the information related to the work issue by issue.

### A Program

It is also possible to generate a program by writing the processes performed by the classification device 10 according to the above embodiments by using a language executable by a computer. In one embodiment, it is possible to implement the classification device 10 by installing, in a desired computer, a classification program that executes the classification processes described above as packaged software or online software. For example, by causing an information processing apparatus to execute the abovementioned classification program, it is possible to cause the information processing apparatus to function as the classification device 10. In this situation, the information processing apparatus includes a personal computer of a desktop type or a notebook type. Further, as other examples, a possible range of the information processing apparatus includes mobile communication terminals such as smartphones, mobile phones, and Personal Handyphone Systems (PHSs), as well as slate terminals such as Personal Digital Assistants (PDAs). Further, functions of the classification device 10 may be implemented in a cloud server.

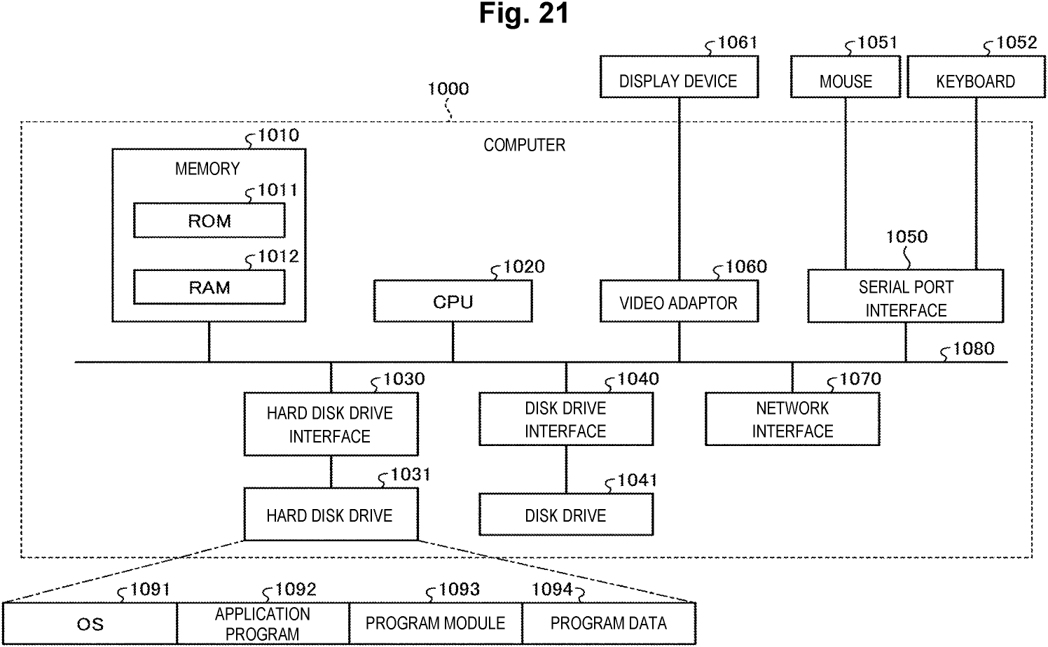

FIG. 21 is a diagram showing an example of the computer that executes the classification program. For example, a computer 1000 includes a memory 1010, a CPU 1020, a hard disk drive interface 1030, a disk drive interface 1040, a serial port interface 1050, a video adaptor 1060, and a network interface 1070. These elements are connected together by a bus 1080.

The memory 1010 includes a Read Only Memory (ROM) 1011 and a RAM 1012. The ROM 1011 stores therein a boot program such as a Basic Input Output System (BIOS), for example. The hard disk drive interface 1030 is connected to a hard disk drive 1031. The disk drive interface 1040 is connected to a disk drive 1041. For example, in the disk drive 1041, a removable storage medium such as a magnetic disk or an optical disk is inserted. To the serial port interface 1050, a mouse 1051 and a keyboard 1052 may be connected, for example. To the video adaptor 1060, a display device 1061 may be connected, for example.

In this situation, for example, the hard disk drive 1031 stores therein, an OS 1091, an application program 1092, a program module 1093, and program data 1094. The pieces of information explained in the above embodiments are stored in the hard disk drive 1031 and the memory 1010, for example.

Further, the classification program is, for example, stored in the hard disk drive 1031, as the program module 1093 in which commands to be executed by the computer 1000 are written. More specifically, the hard disk drive 1031 has stored therein the program module 1093 in which the processes performed by the classification device 10 described in the above embodiments are written.

Further, the data used for the information processing realized by the classification program is stored in the hard disk drive 1031 as the program data 1094, for example. Further, the CPU 1020 executes the procedures described above, by reading, as necessary, the program module 1093 and the program data 1094 stored in the hard disk drive 1031, into the RAM 1012.

The program module 1093 and the program data 1094 related to the classification program do not necessarily have to be stored in the hard disk drive 1031 and may be, for example, stored in a removable storage medium so as to be read by the CPU 1020 via the disk drive 1041 or the like. Alternatively, the program module 1093 and the program data 1094 related to the classification program may be stored in another computer connected via a network such as a LAN or a Wide Area Network (WAN) so as to be read by the CPU 1020 via the network interface 1070.

The embodiments have thus been explained to which the invention conceived of by the present inventor is applied. The present invention, however, is not limited by the description and the drawings, which forms a part of the present invention disclosed by the present embodiments. In other words, all the other embodiments, embodiment examples, implementation techniques, and the like that may be arrived at by a person skilled in the art or the like on the basis of the present embodiments fall within the scope of the present invention.

Reference Signs List

| | |
|---|---|
| 10 | Classification device |
| 11 | Input unit |
| 12 | Output unit |
| 13 | Communication control unit |
| 14 | Storage unit |
| 15 | Control unit |
| 15 a | Obtainment unit |
| 15 b | Extraction unit |
| 15 c | Calculation unit |
| 15 d | Classification unit |

1. A classification device comprising:
an extraction unit including one or more processors, configured to extract words included in information related to work;
a calculation unit including one or more processors, configured to calculate a degree of infrequency of appearance with respect to each of the extracted words; and
a classification unit including one or more processors, configured to classify the information related to the work issue by issue, by using the calculated degrees of infrequency of appearance of the words.

2. The classification device according to claim 1, wherein
the extraction unit is configured to extract the words, with respect to each of information types of the information related to the work.

3. The classification device according to claim 2, wherein
from the words extracted with respect to each of the information types, the extraction unit is configured to exclude a word included in all pieces of information in each information type.

4. The classification device according to claim 2, wherein
the extraction unit is configured to extract the words with respect to each of the information types, by classifying the information related to the work according to the information types by using all the extracted words.

5. The classification device according to claim 2, wherein
the extraction unit is configured to extract the words with respect to each of the information types, by classifying the information related to the work according to the information types, by using words included in a template prepared with respect to each of the information types.

6. The classification device according to claim 1, wherein
among words each having the calculated degree of infrequency of appearance that is equal to or higher than a predetermined threshold value, when a quantity of, or a sum of the degrees of infrequency of appearance of, words appearing in common in pieces of information related to the work is equal to or larger than a predetermined threshold value, the classification unit is configured to classify the pieces of information related to the work as a mutually same issue.

7. A classification method to be implemented by a classification device, the classification method comprising:
extracting words included in information related to work;
calculating a degree of infrequency of appearance with respect to each of the extracted words; and
classifying the information related to the work issue by issue, by using the calculated degrees of infrequency of appearance of the words.

8. A non-transitory computer-readable storage medium storing a classification program that causes a computer to function as the classification device to perform operations comprising:
extracting words included in information related to work;
calculating a degree of infrequency of appearance with respect to each of the extracted words; and
classifying the information related to the work issue by issue, by using the calculated degrees of infrequency of appearance of the words.

9. The classification method according to claim 7, further comprising:
extracting the words, with respect to each of information types of the information related to the work.

10. The classification method according to claim 9, further comprising:
from the words extracted with respect to each of the information types, excluding a word included in all pieces of information in each information type.

11. The classification method according to claim 9, further comprising:
extracting the words with respect to each of the information types, by classifying the information related to the work according to the information types by using all the extracted words.

12. The classification method according to claim 9, further comprising:
extracting the words with respect to each of the information types, by classifying the information related to the work according to the information types, by using words included in a template prepared with respect to each of the information types.

13. The classification method according to claim 9, further comprising:
among words each having the calculated degree of infrequency of appearance that is equal to or higher than a predetermined threshold value, when a quantity of, or a sum of the degrees of infrequency of appearance of, words appearing in common in pieces of information related to the work is equal to or larger than a predetermined threshold value, classifying the pieces of information related to the work as a mutually same issue.

14. The non-transitory computer-readable storage medium according to claim 8, wherein the operations further comprise:
extracting the words, with respect to each of information types of the information related to the work.

15. The non-transitory computer-readable storage medium according to claim 14, wherein the operations further comprise:
from the words extracted with respect to each of the information types, excluding a word included in all pieces of information in each information type.

16. The non-transitory computer-readable storage medium according to claim 14, wherein the operations further comprise:
extracting the words with respect to each of the information types, by classifying the information related to the work according to the information types by using all the extracted words.

17. The non-transitory computer-readable storage medium according to claim 14, wherein the operations further comprise:
extracting the words with respect to each of the information types, by classifying the information related to the work according to the information types, by using words included in a template prepared with respect to each of the information types.

18. The non-transitory computer-readable storage medium according to claim 14, wherein the operations further comprise:
among words each having the calculated degree of infrequency of appearance that is equal to or higher than a predetermined threshold value, when a quantity of, or a sum of the degrees of infrequency of appearance of, words appearing in common in pieces of information related to the work is equal to or larger than a predetermined threshold value, classifying the pieces of information related to the work as a mutually same issue.
